(19) United States
(12) Patent Application Publication
(10) Pub. No.: US 2023/0317338 A1
(43) Pub. Date: Oct. 5, 2023

(54) WINDING SUPPORT FOR A MAGNETIC COMPONENT OF AN ELECTRICAL ASSEMBLY

(71) Applicant: Valeo Siemens eAutomotive Norway AS, Drammen (NO)

(72) Inventors: Yannick SOHIER, Cergy (FR); Boris BOUCHEZ, Drammen (NO); Stephane FONTAINE, Drammen (NO)

(73) Assignee: Valeo Siemens eAutomotive Norway AS, Drammen (NO)

(21) Appl. No.: 18/043,145

(22) PCT Filed: Aug. 27, 2021
(86) PCT No.: PCT/EP2021/073752

§ 371 Date: Feb. 27, 2023

(30) Foreign Application Priority Data
Aug. 31, 2020 (FR) 2008809

(51) Int. Cl. H01F 5/02; H01F 27/32

(52) U.S. Cl. CPC H01F 5/02; H01F 27/325; H01F 2005/022

(57) ABSTRACT

A winding support includes a tube for receiving one of the legs of a ferromagnetic core of a magnetic component such that half-legs of the leg face each other in the tube. The magnetic component further includes windings which correspond to the leg and which are wound on the tube. The winding support includes a wedging protrusion and at least one spacing wall. The wedging protrusion is formed on an inner surface of the tube so as to define an air gap between the opposing half-legs. The at least one spacing wall, which is formed opposite the wedging protrusion and on an outer surface of the tube, is configured to keep at least one of the windings away from the air gap.

### TECHNICAL FIELD AND SUBJECT MATTER OF THE INVENTION

The present invention relates to the field of electrical equipment and of magnetic components, notably for a vehicle.

More precisely, the present invention targets winding supports for magnetic components, notably for electrical transformers, that make it possible to guarantee air gaps of ferromagnetic cores and that are configured to minimize electromagnetic interference.

### PRIOR ART

Lots of systems, notably of electric or hybrid vehicles, comprise electrical equipment and magnetic components such as an electrical transformer allowing electrical energy to be transferred from a primary circuit to a secondary circuit.

As is known, in an electrical transformer, a magnetic core and windings through which flows an electric current that generates a magnetic field allowing electrical energy to be transferred from the primary circuit to the secondary circuit are used. More precisely, in an electrical transformer, in particular in a power converter employing a magnetizing inductance or in a resonant power converter, there is a primary winding and one or more secondary windings, which are wound around a magnetic core, and between which electrical energy is transferred.

An electrical transformer for an electric or hybrid vehicle generally comprises two legs, each of which is composed of a part of the magnetic core with the windings. Nevertheless, given the large power density range, for example the range between 7 kW and 22 kW, a transformer comprising three or even more legs in order to be adapted to the high power density requirement is envisaged.

However, there are very few transformer products with three legs, such as the transformer 3 with three legs illustrated in FIG. 1, for an electric or hybrid vehicle. The transformer 3 is a three-phase electrical transformer comprising a ferromagnetic core 30 and its three legs, comprising an inner leg 32 and two lateral legs 31, 33. On each of the legs 31, 32, 33, a primary winding 510 and a secondary winding 520 are wound on different portions of the leg 31, 32 or 33. E-shaped ferromagnetic half-cores 30a and 30b are notably known, as shown in FIG. 1.

The primary windings 510 are wound on the ferromagnetic half-core 30a, and the secondary windings 520 are wound on the ferromagnetic half-core 30b. The ferromagnetic core 30 and the primary windings 510 and secondary windings 520 are housed in a radiator forming part of a frame that is generally made of a material exhibiting good thermal conductivity, suitable for dissipating heat produced by said transformer 3.

Each of the three legs 31, 32, 33 is formed of two half-legs, one of which forms part of the first ferromagnetic half-core 30a and the other of which forms part of the second ferromagnetic half-core 30b. The two half-legs of the leg 31, 32 or 33 are facing and separated by an air gap 801 which is a space between the two half-legs, as illustrated in FIG. 1. The air gap 801 makes it possible, by flattening the hysteresis curve and by decreasing the permeability of the ferromagnetic core 30, to better manage the energy.

For the three-phase transformer 3, the three air gaps on the three legs 31, 32, 33 have to be identical, irrespective of whether the lengths of the half-legs of the legs 31, 32, 33 are identical. In one example in which the two half-legs of the inner leg 32 are shorter than those of the lateral legs 31 and 33, which have the same length, the distance between the two half-legs of the inner leg 32 may be greater than that between two half-legs of the lateral leg 31 or 33. It is nevertheless not desired for the air gap on the inner leg 32 to be greater than that on the lateral leg 31 or 33.

In order to guarantee that the air gap on the inner leg 32 is identical to that on the lateral leg 31 or 33, a plate of additional thickness may be added to one of the two half-legs of the inner leg 32. The plate of additional thickness is made of a material such as plastic, epoxy, ceramic, etc.

Nevertheless, the addition of the plate of additional thickness could complicate the manufacture and/or the assembly process of the magnetic component. Moreover, this addition does not necessarily guarantee the formation of identical air gaps on the legs of the ferromagnetic core 30. Moreover, the windings wound on the leg 31, 32 or 33 of the ferromagnetic core 30 may be too close to the air gap, leading to magnetic fringing effect losses.

In this context, the present invention therefore targets a solution for forming identical air gaps on the legs of the ferromagnetic core in a simple manner in terms of the manufacture and/or assembly process of the magnetic component and of the electrical assembly. Moreover, the invention also targets a solution which makes it possible to reduce the magnetic losses generated if the windings that are wound on the winding supports are not far enough away from the air gaps.

### GENERAL DESCRIPTION OF THE INVENTION

To that end, the present invention targets a winding support comprising a tube intended to receive one of the legs of a ferromagnetic core of a magnetic component, such that half-legs of said leg are facing in the tube, the magnetic component further comprising windings which correspond to said leg and which are wound on the tube. Said winding support comprises a wedging protrusion and at least one spacing wall. The wedging protrusion is formed on an internal surface of the tube, so as to define an air gap between said facing half-legs. The at least one spacing wall, formed facing the wedging protrusion and on an external surface of said tube, is configured to space apart at least one of the windings from said air gap.

The invention thus makes it possible to form identical air gaps on the legs of the ferromagnetic core in a simple manner in terms of the manufacture and/or assembly process of the magnetic component and of the electrical assembly. The winding supports according to the invention make it possible to guarantee the insertion of the half-legs in the tubes of the winding supports, and to center the air gaps with respect to the windings wound on said tubes. Moreover, the invention also makes it possible to reduce the magnetic losses generated if the windings that are wound on the winding supports are not far enough away from the air gaps.

Advantageously, the wedging protrusion, having a thickness parallel to a longitudinal axis of said tube, is formed orthogonally with respect to said internal surface of the tube; the dimension of said air gap being defined as a function of the thickness of the wedging protrusion.

Preferably, a section of the wedging protrusion, said section being transverse to the longitudinal axis of said tube, is in the form of a ring; said height being perpendicular to said internal surface of the tube.

Advantageously, the winding support comprises a receiving cavity defined by the wedging protrusion such that an adhesive used during the manufacture of the magnetic component can spread out into said receiving cavity; said receiving cavity being a space between facing portions of the wedging protrusion.

Preferably, the at least one spacing wall, having a thickness parallel to the longitudinal axis of said tube, is formed perpendicularly with respect to the external surface of the tube.

Advantageously, a section of the at least one spacing wall, said section being transverse to the longitudinal axis of said tube, is in the form of a ring.

Preferably, the thickness of the wedging protrusion and/or the thickness of the at least one spacing wall are uniform.

Advantageously, the wedging protrusion and/or the at least one spacing wall are formed at an intermediate plate; said intermediate plate separating the windings that are wound on the tube of the winding support.

Preferably, the wedging protrusion and/or the at least one spacing wall are formed integrally with the winding support.

Advantageously, the winding support is a single piece manufactured by molding.

Preferably, the winding support is made of plastics material.

Advantageously, the winding support is configured to be housed in a cavity of a frame comprising mechanical upright portions, such that said mechanical upright portions are placed in a spacing between two adjacent legs of the ferromagnetic core.

The invention also relates to an electrical assembly comprising a magnetic component and winding supports, said winding supports each comprising a tube configured to receive half-legs of one of a plurality of legs of a ferromagnetic core of said magnetic component; for each of said legs, the magnetic component further comprising windings which correspond to said leg and which are wound on the tube in which the half-legs of the leg are facing. Each of the winding supports of said electrical assembly comprises a wedging protrusion and at least one spacing wall. The wedging protrusion is formed on an internal surface of the tube, so as to define an air gap between two facing half-legs of the leg. Said at least one spacing wall, formed facing the wedging protrusion and on an external surface of said tube, is configured to space apart at least one of the windings from said air gap.

Advantageously, the magnetic component has air gaps respectively defined by one of the winding supports, the air gaps being identical on the legs of the ferromagnetic core.

Preferably, the electrical assembly comprises a frame and mechanical upright portions. Said frame comprises a cavity in which the winding supports and the magnetic component are housed. The mechanical upright portions are placed in a spacing between two adjacent legs of the ferromagnetic core, so as to homogenize the dissipation of heat generated during operation of the magnetic component.

The invention also relates to an item of electrical equipment comprising an electrical assembly as described above.

### PRESENTATION OF THE FIGURES

The invention will be better understood from reading the following description, given solely by way of example, and with reference to the attached drawings given by way of non-limiting examples, in which identical references are given to similar objects and in which:

FIG. 1 is a schematic representation of a known electrical transformer with three legs;

FIG. 2 illustrates an electrical assembly comprising an electrical transformer with three legs that is housed in a frame, according to one embodiment of the invention;

FIG. 3 illustrates, without the presence of the windings of one branch of the magnetic component, the electrical assembly according to one embodiment of the invention;

FIG. 4 illustrates, without the presence of the magnetic component, the frame comprising mechanical upright portions, according to one embodiment of the invention;

FIG. 5 illustrates a winding support according to one embodiment of the invention;

FIG. 6 illustrates the winding support from a perspective that differs from that of FIG. 5;

FIG. 7 illustrates the winding support from a perspective that differs from those of FIGS. 5 and 6;

FIG. 8 illustrates the cross section A-A of the winding support in FIG. 5;

FIG. 9 illustrates the cross section A-A of the winding support from a perspective that differs from that of FIG. 8.

It should be noted that the figures set out the invention in detail so as to allow the invention to be implemented, it of course being possible for said figures to be used to better define the invention if necessary.

### DETAILED DESCRIPTION OF THE INVENTION

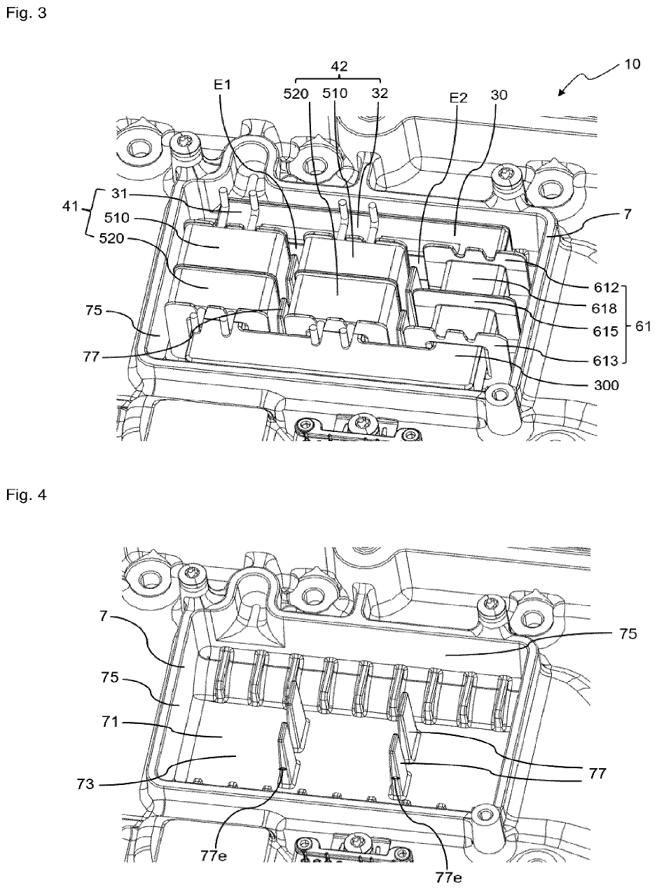

FIGS. 2 and 3 illustrate a electrical assembly 10 according to one embodiment of the invention. The electrical assembly 10 comprises a magnetic component 300 and a frame 7 configured to receive the magnetic component 300.

The electrical assembly 10 and its elements are notably provided for an electric or hybrid vehicle. The electrical assembly 10 according to the invention is thus, for example, intended to be integrated into an item of electrical equipment such as a power electronics module of the vehicle. The power electronics module is configured to enable a controlled passage of electrical energy between a high-voltage supply battery and an electric machine of the vehicle. More precisely, “power electronics module” is understood to mean an assembly comprising components via which energy powering the electric machine passes, and which are notably intended to convert direct current to alternating current, or vice versa. These components may comprise electronic switches, such as semiconductor transistors, arranged in an electrical circuit so as to enable a controlled passage of electrical energy between the high-voltage supply battery and the electric machine. In particular, the components are bare semiconductor chips which are encapsulated by the body. In other words, a power electronics module is an assembly comprising a plurality of semiconductor chips that form an electrical circuit and are encapsulated in one and the same casing.

The magnetic component 300 comprises a ferromagnetic core comprising a plurality of legs. The legs comprise at least one inner leg which is sandwiched between two adjacent legs of the magnetic component 300. In other words, the at least one inner leg is not adjacent to walls 75 of a cavity 71 that is formed in the frame 7 to receive the magnetic component 300. The legs further comprise lateral legs which are adjacent both to the walls 75 of the cavity 71 and to the at least one inner leg.

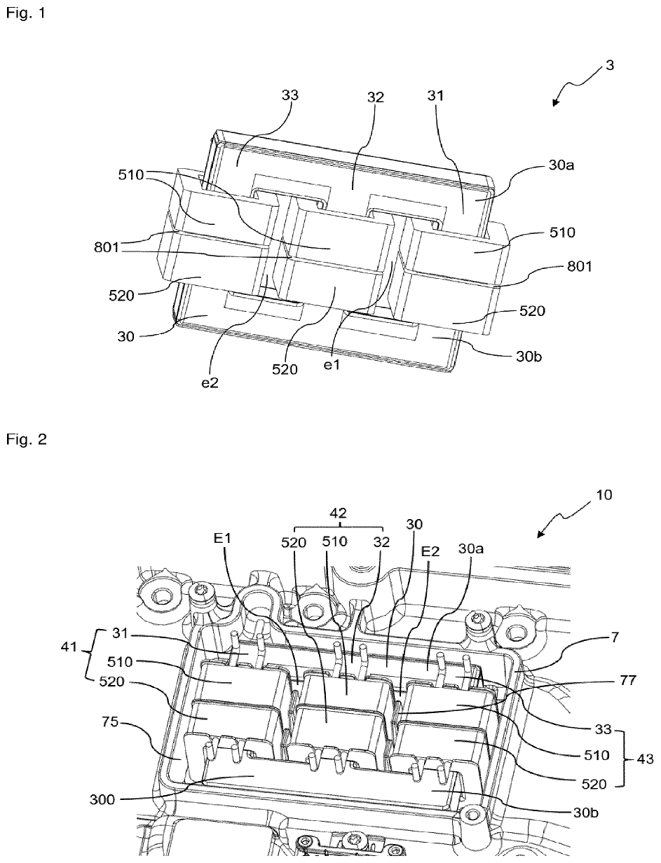

In the present embodiment, said magnetic component 300 is a transformer with three legs having a structure similar to that of the transformer 3 as described above and in FIG. 1. Thus, elements of the magnetic component 300 which have functions and names similar or even identical to those of the transformer 3 are indicated by the same reference numbers (e.g. legs 31 to 33). The invention is not limited to the type of magnetic component or to the number of legs. According to the invention, the magnetic component 300 may be, for example, a converter having a ferromagnetic core comprising more than three legs.

The magnetic component 300 comprises a ferromagnetic core 30 which has three legs 31, 32, 33, namely two lateral legs 31, 33 and an inner leg 32. In order to facilitate assembly during the manufacture of the magnetic component 300, the ferromagnetic core 30 preferably comprises a first ferromagnetic half-core 30a and a second ferromagnetic half-core 30b, which are both E-shaped. Each of the three legs 31, 32, 33 is formed of two half-legs, one of which forms part of the first ferromagnetic half-core 30a and the other of which forms part of the second ferromagnetic half-core 30b. In one embodiment, the half-legs have identical lengths. Alternatively, the half-legs have different lengths. The two half-legs of each leg are facing and separated by an air gap which makes it possible, by flattening the hysteresis curve and by decreasing the permeability of the ferromagnetic core 30, to better manage the energy.

In one example in which the magnetic component 300 is a three-phase electrical transformer, each leg 31, 32, 33 corresponds to one phase of the three-phase electrical transformer. At least two windings are disposed for each of the legs 31 to 33. More precisely, on each of the legs 31 to 33, a primary winding 510 and at least one secondary winding 520 are respectively wound on one of the half-legs of the leg. In the example illustrated in FIG. 2, a single secondary winding 520 is present on each of the legs 31, 32, 33. The primary windings 510 are wound on the half-legs which form part of the ferromagnetic half-core 30a while the secondary windings 520 are wound on the half-legs which form part of the ferromagnetic half-core 30b. It is noted that the invention is not limited to the realization of the magnetic component 300.

FIG. 4 illustrates, without the presence of the magnetic component 300, the frame 7 comprising mechanical upright portions 77 (which will be described in detail below), according to one embodiment of the invention. The frame 7 preferably forms a heat dissipation radiator 7 which serves as passive cooling module configured to promote the dissipation of heat generated during operation of the magnetic component 300. The radiator 7 may be an existing element of the electric or hybrid vehicle in which the magnetic component 300 is installed. The frame 7 is preferably made of a material exhibiting good thermal conductivity, for example aluminum.

Said cavity 71, formed in the frame 7 to receive at least one winding support 61 (which will be described in detail below) and the magnetic component 300, is delimited by the walls 75 and by a lower surface 73 forming part of a first surface of the frame 7. The lower surface 73 is the bottom of the cavity 71. The walls 75 are preferably perpendicular to said lower surface 73. In an advantageous embodiment, the walls 75 extend, in a perpendicular manner, from said lower surface 73.

According to one embodiment, the electrical assembly 10 further comprises an active cooling module (not illustrated in the figures) installed at a second surface of the frame 7, the second surface being opposite to said first surface on which said cavity 71 is formed. The active cooling module comprises, for example, a cooling liquid inlet and a cooling liquid outlet. A cooling liquid (e.g. water) circulates in ducts that are situated in the active cooling module, so as to cool the frame 7, the magnetic component 300 and other elements disposed in the vicinity.

Each leg and the windings 510 and 520 wound on said leg are considered a branch of the magnetic component 300. As illustrated in FIG. 2, the magnetic component 300 comprises three branches 41 to 43, the inner branch 42 of which comprises the inner leg 32 and the windings 510 and 520 wound on the inner leg 32. The lateral branch 41 comprises the lateral leg 31 of the ferromagnetic core 30 and the windings 510 and 520 wound on the lateral leg 31. The lateral branch 43 comprises the lateral leg 33 and the corresponding windings 510 and 520.

As illustrated in FIG. 3, the electrical assembly 10 comprises winding supports 61 (also called “coil formers”), each of which is intended to receive one of the branches 41, 42 or 43 of the magnetic component 300. One of the winding supports 61 which corresponds to one of the branches 41 to 43 is installed between the leg of said branch and the windings 510 and 520, so as to position the windings 510, 520 on said leg.

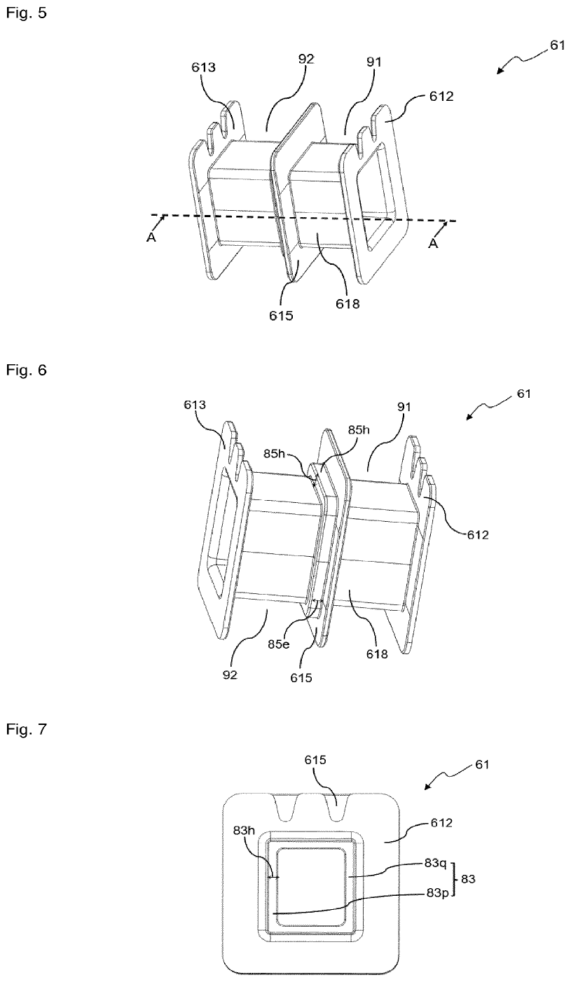

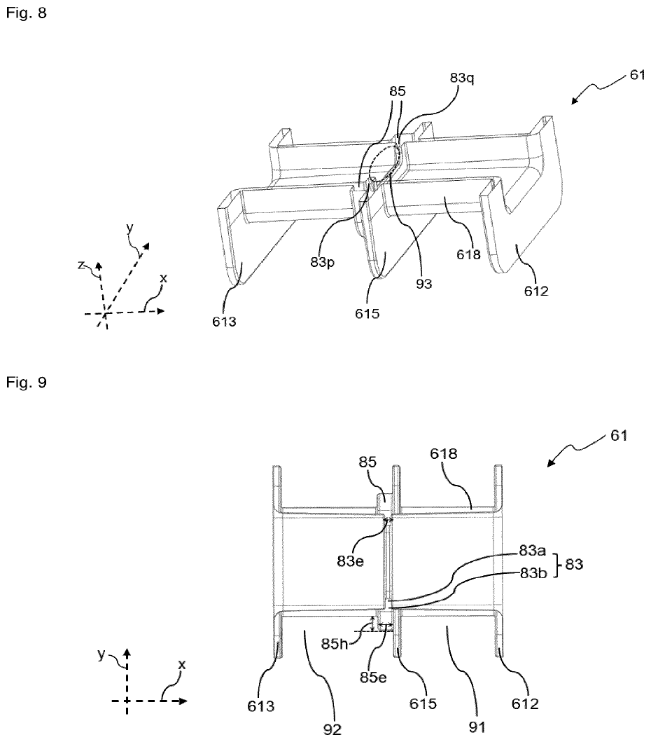

In order to describe the structure and the form of the winding supports 61 in greater detail, an example of a single winding support 61 is illustrated in FIGS. 5 to 9. FIGS. 5 to 7 illustrate the winding support 61 from different perspectives. FIGS. 8 and 9 illustrate, from two different perspectives, a cross section A-A of the winding support 61 as indicated in FIG. 5.

The winding support 61 comprises a tube 618, end plates 612, 613 and at least one intermediate plate 615. The winding supports 61 are preferably made of plastics material or of xxx. The tube 618 of the winding support 61 allows the leg to pass through it. The tube 618 has a cross section that is greater than or equal to that of said leg received by the tube 618. The cross section of the tube 618 is perpendicular to a longitudinal axis of said tube 618, which is, for example, in parallel with the axis “x” in FIG. 5. The three axes x, y, z represent three dimensions of a space in which the winding support 61 exists.

In a similar manner, the cross section of said leg is orthogonal to a longitudinal axis of said leg of the ferromagnetic core 30. Said two cross sections are of square or rectangular form. Alternatively, the cross sections may be of round form. The invention is not limited to the form of the cross section of the tube 618 or that of the leg received by the tube 618.

The winding support 61 receiving said leg further comprises a wedging protrusion 83 formed on an internal surface of the tube 618, so as to define said air gap which is a space between the two half-legs of the leg, the two half-legs being facing. More precisely, the two half-legs, which respectively belong to the ferromagnetic half-cores 30a and 30b, come into abutment against the wedging protrusion 83 of the winding support 61. Preferably, the magnetic component 300 has air gaps which are defined by the winding supports 61 and which are identical on the legs of the ferromagnetic core 30.

Moreover, the wedging protrusion 83 is also configured to guarantee the insertion of the half-legs in the tube 618 and to center said air gap with respect to the windings 510, 520 wound on the tube 618 of the winding support 61.

The wedging protrusion 83 is preferably formed perpendicularly with respect to said internal surface of the tube 618 and all the way round said internal surface. The wedging protrusion 83 has a height 83h perpendicular to said internal surface of the tube 618, and a thickness 83e parallel to the longitudinal axis of said tube 618. The dimension of said air gap is defined as a function of the thickness 83e of the wedging protrusion 83. Said height 83h is preferably between 0.8 and 5 mm (millimeter). Said thickness 83e is preferably between 0.5 and 2.5 mm, for example 1 mm. A section of the wedging protrusion 83, said section being transverse to the longitudinal axis of said tube 618, is in the form of a ring. Advantageously, the wedging protrusion 83 is, as illustrated in FIGS. 8 and 9, formed at the at least one intermediate plate 615 which separates the windings 510, 520 wound on the tube 618.

In one embodiment, the thickness 83e of the wedging protrusion 83 is uniform. In an alternative embodiment, the wedging protrusion 83 comprises a first and a second portion 83a and 83b which have different thicknesses. With respect to the second portion 83b, the first portion 83a is a portion of the wedging protrusion 83 that is closer to a central axis inside the tube 618. With respect to the rest of the wedging protrusion 83 (i.e. the second portion 83b which has a thickness for example of 1 mm), the first portion 83a has a reduced thickness such as 0.9 mm. Such a difference in thickness between the portions 83a and 83b of the wedging protrusion 83 is configured to guarantee the insertion of the half-legs of the leg in the tube 618 and to define said air gap.

Moreover, it is desired that, during the manufacture of the magnetic component 300, an adhesive used can spread out into a dedicated cavity. To this end, a receiving cavity 9, being a space between facing portions 83p and 83q of the wedging protrusion 83 (as illustrated in FIGS. 7 and 8), is defined by the wedging protrusion 83.

The air gap is formed without the presence of additional elements. In other words, said air gap, defined for example by the manufacturer of the magnetic component 300, is formed with other portions of the winding support 61 as a single piece manufactured, for example, by molding. It is therefore simple to form identical air gaps on the legs of the ferromagnetic core 30.

The first and the second end plate 612, 613 and the at least one intermediate plate 615 of the winding support 61 are formed on an external surface of the tube 618, so as to receive the windings (510, 520) of the branch (41, 42 or 43). Said plates 612, 613, 615, intended to delimit winding zones that are configured to receive the windings of the branch, preferably stem, in a perpendicular manner, from the external surface of the tube 618. The end plates 612, 613 and the at least one intermediate plate 615 are perpendicular to the longitudinal axis of said tube 618. Preferably, the end plates 612, 613 and the at least one intermediate plate 615 are both parallel to one another and perpendicular to the tube 618.

For each winding support 61, the number of intermediate plates 615 is determined as a function of the number of windings of the branch. In one embodiment in which the branch comprises three windings, the winding support 61 may comprise two intermediate plates 615. In the present embodiment in which the branch comprises two windings, the winding support 61 comprises a single intermediate plate 615, as described in FIGS. 2 to 9.

As mentioned above, the winding zones, which are respectively configured to receive one of the windings of the branch, are respectively delimited by the external surface of the tube 618 and the two adjacent plates from among the end plates 612, 613 and the at least one intermediate plate 615.

According to the example illustrated in FIGS. 5 to 9, a first winding zone 91, intended to receive the primary winding 510 of the branch (e.g. the branch 41), is delimited by the end plate 612, the external surface of the tube 618 and the intermediate plate 615. A second winding zone 92, intended to receive the secondary winding 520 of said branch, is delimited by the end plate 613, the external surface of the tube 618 and the intermediate plate 615. In this way, the primary winding 510 and the secondary winding 520 are wound on the winding support 61 which slots onto the two ferromagnetic half-cores 30a and 30b.

The winding support 61 further comprises at least one spacing wall 85 configured to space apart at least one of the windings 510 and 520 from said air gap, so as to reduce magnetic fringing effect losses. Magnetic losses generated if at least one of the windings 510, 520 that are wound on the tube 618 of the winding support 61 is not far enough away from said air gap defined by the wedging protrusion 83. The at least one spacing wall 85, formed on the external surface of said tube 618, is situated facing the wedging protrusion 83.

The at least one spacing wall 85 has a thickness 85e parallel to the longitudinal axis of said tube 618. Said thickness 85e is preferably between 0.8 and 4 mm. In a preferred embodiment, the thickness 85e of the at least one spacing wall 85 is preferably uniform.

The at least one spacing wall 85 is preferably formed perpendicularly with respect to said external surface of the tube 618 and all the way round said external surface. A section of the at least one spacing wall 85, said section being transverse to the longitudinal axis of said tube 618, is in the form of a ring. Advantageously, the at least one spacing wall 85 is formed at the at least one intermediate plate 615, as illustrated in FIGS. 6, 8 and 9. In the present embodiment in which one of the winding supports 61 comprises a single intermediate plate 615, the winding support 61 comprises a single spacing wall 85. In an alternative embodiment in which one of the winding supports 61 comprises a plurality of intermediate plates 615, the winding support 61 may comprise a plurality of spacing walls 85, each of which is situated at one of the intermediate plates 615.

Advantageously, the at least one spacing wall 85 may be formed in the second winding zone 92 (as illustrated in FIGS. 5 to 9) or in the first winding zone 91. In an alternative embodiment, the at least one spacing wall 85 comprises two spacing walls that are respectively formed in the first winding zone 91 and in the second winding zone 92. The two spacing walls are preferably similar or even identical to the example of the spacing wall 85 above in terms of form, structure and/or dimensions. Advantageously, the thicknesses of the two spacing walls may respectively be between 0.8 and 3 mm, for example half the thickness 85e as described above.

Preferably, the wedging protrusion 83 and/or the at least one spacing wall 85 are formed integrally with the winding support 61. According to a preferred embodiment, the winding support 61 comprising the wedging protrusion 83 and the at least one spacing wall 85 is a single piece manufactured, for example, by molding. The manufacture of the winding support 61 and the assembly process of the magnetic component 300, and also that of the electrical assembly 10, are thus simplified.

With respect to the at least one inner branch of the magnetic component 300, the lateral branches of the magnetic component 300 dissipate heat to the walls 75 of the cavity 71 more easily.

In order to homogenize the heat dissipation and to improve cooling, the electrical assembly 10 comprises at least one mechanical upright portion 77 made of a material exhibiting suitable good thermal conductivity (e.g. aluminum) and placed between two adjacent branches from among the branches of the magnetic component 300. More precisely, one or more mechanical upright portions 77 are placed in a spacing between two adjacent branches which comprise at least one inner branch, so as to homogenize the dissipation of heat coming from the two adjacent branches. More precisely, the two adjacent branches comprise either an inner branch and a lateral branch or two inner branches (this may be the case if the magnetic component 300 comprises more than three branches). Thus, the temperature of the at least one inner branch no longer risks being excessively high.

There are a plurality of spacings respectively situated between two adjacent branches of the magnetic component 300, such as a first and a second spacing E1 and E2. The first spacing is situated between the inner branch 42 and the lateral branch 41 which is adjacent to the inner branch 42. The second spacing E2 is situated between the inner branch 42 and the lateral branch 43 which is adjacent to the inner branch 42. In order to ensure the homogenization of the heat dissipation with respect to all branches of the magnetic component 300, one or more mechanical upright portions 77 are placed in each of the spacings, as illustrated in FIGS. 2 and 3. Thus, the at least one mechanical upright portion 77 (i.e. the four mechanical upright portions 77 illustrated in FIG. 4) on either side of the at least one inner branch (e.g. the inner branch 42), makes it possible to homogenize the dissipation of heat coming from the branches of the magnetic component 300, and to improve, in particular, the dissipation of heat coming from the at least one inner branch 42.

In one embodiment, the at least one mechanical upright portion 77 is an upright portion made of a material exhibiting suitable thermal conductivity, for example aluminum. The at least one mechanical upright portion 77 preferably has a thickness 77e greater than or equal to 3 mm. The size of the electrical assembly 10 is determined as a function of the thickness 77e of the at least one mechanical upright portion 77. If the thickness 77e of the at least one mechanical upright portion 77 is low, the magnetic component 300 and the electrical assembly 10 have a reduced size.

The at least one mechanical upright portion 77 is preferably perpendicular to said lower surface 73. Advantageously, the at least one mechanical upright portion 77 stems from the frame 7. According to a preferred embodiment, the frame 7 comprising the walls 75 and the mechanical upright portions 77 is a single piece manufactured, for example, by molding.

As mentioned above, the invention makes it possible to form identical air gaps on the legs of the ferromagnetic core in a simple manner in terms of the manufacture and/or assembly process of the magnetic component and of the electrical assembly. The winding supports according to the invention make it possible to guarantee the insertion of the half-legs in the tubes of the winding supports, and to center the air gaps with respect to the windings wound on said tubes. Moreover, the invention also makes it possible to reduce the magnetic losses generated if the windings that are wound on the winding supports are not far enough away from the air gaps.

The invention is not limited to the embodiments described above but encompasses any embodiment conforming to its spirit.

1. A winding support comprising a tube intended to receive one of the legs of a ferromagnetic core of a magnetic component, such that half-legs of said leg are facing in the tube, the magnetic component further comprising windings which correspond to said leg and which are wound on the tube; wherein the winding support comprises:
a wedging protrusion formed on an internal surface of the tube, so as to define an air gap between said facing half-legs; and
at least one spacing wall, formed facing the wedging protrusion and on an external surface of said tube, and configured to space apart at least one of the windings from said air gap.

2. The winding support as claimed in claim 1, wherein the wedging protrusion, having a thickness parallel to a longitudinal axis of said tube, is formed orthogonally with respect to said internal surface of the tube; the dimension of said air gap being defined as a function of the thickness of the wedging protrusion.

3. The winding support as claimed in claim 2, wherein a section of the wedging protrusion, said section being transverse to the longitudinal axis of said tube of the wedging protrusion, is in the form of a ring; said height being perpendicular to said internal surface of the tube.

4. The winding support as claimed in claim 1, comprising a receiving cavity defined by the wedging protrusion such that an adhesive used during the manufacture of the magnetic component can spread out into said receiving cavity; said receiving cavity being a space between facing portions of the wedging protrusion.

5. The winding support as claimed in claim 2, wherein the at least one spacing wall, having a thickness parallel to the longitudinal axis of said tube, is formed perpendicularly with respect to the external surface of the tube.

6. The winding support as claimed in claim 5, wherein a section of the at least one spacing wall, said section being transverse to the longitudinal axis of said tube, is in the form of a ring.

7. The winding support as claimed in claim 1, wherein the thickness of the wedging protrusion and/or the thickness of the at least one spacing wall are uniform.

8. The winding support as claimed in claim 1, wherein the wedging protrusion and/or the at least one spacing wall are formed at an intermediate plate; said intermediate plate separating the windings that are wound on the tube of the winding support.

9. The winding support as claimed in claim 1, wherein the wedging protrusion and/or the at least one spacing wall are formed integrally with the winding support.

10. The winding support as claimed in claim 1, being a single piece manufactured by molding.

11. The winding support as claimed in claim 1, being made of plastics material.

12. The winding support as claimed in claim 1, configured to be housed in a cavity of a frame comprising mechanical upright portions, such that said mechanical upright portions are placed in a spacing between two adjacent legs of the ferromagnetic core.

13. An electrical assembly comprising a magnetic component and winding supports, said winding supports each comprising a tube configured to receive half-legs of one of a plurality of legs of a ferromagnetic core of said magnetic component; for each of said legs, the magnetic component further comprising windings which correspond to said leg and which are wound on the tube in which the half-legs of the leg are facing; the electrical assembly being wherein each of the winding supports comprises:
a wedging protrusion formed on an internal surface of the tube, so as to define an air gap between two facing half-legs of the leg; and
at least one spacing wall, formed facing the wedging protrusion and on an external surface of said tube, and configured to space apart at least one of the windings from said air gap.

14. The electrical assembly as claimed in claim 13, wherein the magnetic component has air gaps respectively defined by one of the winding supports, the air gaps being identical on the legs of the ferromagnetic core.

15. The electrical assembly as claimed in claim 13, comprising:
a frame comprising a cavity in which the winding supports and the magnetic component are housed;
mechanical upright portions placed in a spacing between two adjacent legs of the ferromagnetic core, so as to homogenize the dissipation of heat generated during operation of the magnetic component.

16. An item of electrical equipment comprising an electrical assembly as claimed in claim 13.

17. The winding support as claimed in claim 2, comprising a receiving cavity defined by the wedging protrusion such that an adhesive used during the manufacture of the magnetic component can spread out into said receiving cavity; said receiving cavity being a space between facing portions of the wedging protrusion.

18. The winding support as claimed in claim 3, wherein the at least one spacing wall, having a thickness parallel to the longitudinal axis of said tube, is formed perpendicularly with respect to the external surface of the tube.

19. The winding support as claimed in claim 2, wherein the thickness of the wedging protrusion and/or the thickness of the at least one spacing wall are uniform.

20. The winding support as claimed in claim 2, wherein the wedging protrusion and/or the at least one spacing wall are formed at an intermediate plate; said intermediate plate separating the windings that are wound on the tube of the winding support.
